(19) United States
(12) Patent Application Publication
(10) Pub. No.: US 2010/0258327 A1
(43) Pub. Date: Oct. 14, 2010

(54) ELECTRICALLY DRIVEN HAND-HELD POWER TOOL

(76) Inventors: Florian Esenwein, Uhingen-Holzhausen (DE); Albrecht Hofmann, Steinenbronn (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/745,050

(22) PCT Filed: Sep. 29, 2008
(86) PCT No.: PCT/EP2008/062990

§ 371 Date: May 27, 2010

(30) Foreign Application Priority Data
Nov. 27, 2007 (DE) 10 2007 057 033.5

(51) Int. Cl. B25F 5/00

(52) U.S. Cl. 173/217

(57) ABSTRACT

The invention relates to an electrically driven hand-held power tool having a drive motor that is configured as a commutator motor having a brush for current transfer to the commutator. A removable cover is received in the housing that is the carrier of a spring element, which exerts a spring force in the mounted state on the brush in the direction of the commutator.

The invention relates to an electrically drivable hand-held power tool with the defining characteristics of the preamble to claim 1.

### PRIOR ART

DE 10 2004 050 798 A1 describes a hand-held power tool with a drive shaft that is driven by an electric motor and can be driven in an oscillating fashion. For this purpose, the housing of the hand-held power tool accommodates an electric motor that uses a motor shaft to drive an eccentric disk that is engaged by an arm, which is connected to the drive shaft for co-rotation with it, in order to convert the rotary motion of the eccentric disk into an oscillatory motion of the drive shaft.

As a rule, in hand-held power tools of this kind, universal motors are used as the electric drive unit, which are operated with alternating current and in order to use the current, are provided with a commutator, which is affixed to the armature and is contacted by brushes affixed to the housing in order to transmit current to the armature winding. Because of the sliding motion, the brushes are subject to wear and must be replaced for maintenance purposes. For this reason, it is necessary to assure that the procedure of removing the brushes from the housing and replacing them can be accomplished with an acceptable level of effort. It is simultaneously necessary to assure that during regular operation, a sufficient contact is produced between the brushes and commutator to assure a reliable transmission of current.

### DISCLOSURE OF THE INVENTION

The object of the invention is to embody an electrically drivable hand-held power tool to permit a brush change to be carried out by means of simple steps.

This object is attained according to the invention by means of the defining characteristics of claim 1. The dependent claims disclose suitable modifications.

The hand-held power tool according to the invention has an electric drive motor that is embodied in the form of a commutator motor equipped with a brush for transmitting current to a commutator. In the housing of the hand-held power tool, a detachable cover is provided that supports a spring element, which in the installed position, acts on the brush with a spring force in the direction toward the commutator.

This embodiment makes it possible on the one hand when removing the cover, which closes an opening in the housing, to simultaneously also remove the spring element that is secured to the cover. This eliminates an additional work step in which the spring element would otherwise first have to be removed from the housing of the hand-held power tool after the removal of the cover. The removal of the spring element, however, is required in order to access the brush and in order to remove the brush.

It is, however, also possible not to remove the spring from the device, but instead, after having opened the cover, to lift the spring and position it next to the carbon brush in a sort of parking position, whereupon the carbon brush can be removed from the cup.

On the other hand, with the aid of the spring element, a sufficiently powerful force is produced that acts on the brush and exerts a force on it in the direction toward the commutator, thus assuring a sufficiently good contact between the brush and commutator and therefore also a functioning current supply in the armature with which the commutator rotates in order to produce an electromagnetic alternating field.

Another advantage lies in the fact that the spring situated on the inside of the cover, because of its prestressing force, acts on the cover with a lifting reaction force that acts in opposition to the force acting on the brush. As a result of this, the force of the spring element lifts the cover as soon as the lock of the cover is released. Consequently, removing the cover and therefore also the spring element secured to the cover requires no additional tools.

After the removal of the cover and the spring element, the brush inside the housing is freely accessible and can be removed for maintenance purposes. According to another embodiment, however, it can also be useful to secure the brush as well as the spring element to the inside of the cover, for which purpose a brush holder or part of a brush holder is advantageously provided on the cover. This brush holder permits at least a slight relative movement between the accommodated brush and the cover in order to permit the action of the spring element to press it against the commutator.

It is also possible for a replaceable module to be composed of the brush holder, spring, and cover. The supply of current can then be achieved, for example, via a blade connector provided between the handheld power tool and this module.

According to an advantageous modification, a support plate that supports the spring element is situated on the cover. This support plate, which is preferably embodied as integral to the cover, but can also be embodied as a separate part to be attached to the cover, preferably extends in a plane perpendicular to the cover. The support plate can have a retaining journal situated on it, which serves to accommodate the spring element. The support plate is preferably embodied as integral to the cover, which is suitably embodied in the form of an injection molded plastic part. In addition, a boss for accommodating a screw can be provided on the cover, which is preferably likewise integral to it, in order to firmly attach the cover to the housing in the installed position. By contrast, the retaining journal provided on the support plate to retain the spring element can be composed of another material, in particular metal. The same is true for a stop, which is provided on the support plate and whose function is to limit the return movement of the spring element. For example, the stop is embodied in the form of a pin or journal or the like.

The support plate extending toward the housing interior, which is oriented at least approximately perpendicular to the plane of the cover, is advantageously connected to the boss, thus improving the stability of the support plate, particularly with regard to bending forces. The support plate offers sufficient space for installing and securing the spring element, the retaining journal, and the stop.

According to another advantageous embodiment, the spring element is embodied in the form of a spiral spring whose center is slid onto the retaining journal so that the rotation axis of the spiral spring coincides with the axis of the retaining journal The stop serves to limit the return movement of the spiral spring so that it can be inserted into the housing with a prestressing force. After the cover is set into place and fastened to the housing, the free end of the spring element rests against the brush and acts on it with a force oriented toward the commutator.

Other advantages and suitable embodiments can be inferred from the remaining claims, the description of the drawings, and the drawings themselves.

### DRAWINGS

FIG. 1 is a view of an angle grinder whose tool is driven by an electric motor embodied in the form of a universal motor, with a depiction of the armature of the electric motor and the commutator connected to it, against which a brush for transmitting the current lies, which has a force exerted on it by a spiral spring that is secured to a detachable cover,

FIG. 2 is a detail view of the cover, with a support plate extending from the underside of the cover,

FIG. 3 is a depiction corresponding to FIG. 2, but with an additional spiral spring that is mounted on a retaining journal on the support plate,

FIG. 4 is a depiction corresponding to FIG. 3, but depicted with an additional brush on which a force is exerted by the spiral spring,

FIG. 5 is a perspective depiction of the underside of the cover,

FIG. 6 is a view of the underside of the cover,

FIG. 7 shows the cover in a modified embodiment in which the support plate extends diagonally on the underside of the cover,

FIG. 8 is a depiction of the cover in the housing of the hand-held power tool, pivoted into the open position,

FIG. 9 is a detail view of the retaining journal for accommodating the spiral spring,

FIG. 10 shows the cover in a modified embodiment, with additional guide pins, which, in the installed position, protrude into associated recesses in the housing,

FIG. 11 is a view of the underside of the cover shown in FIG. 10.

In the drawings, components that are the same have been provided with the same reference numerals.

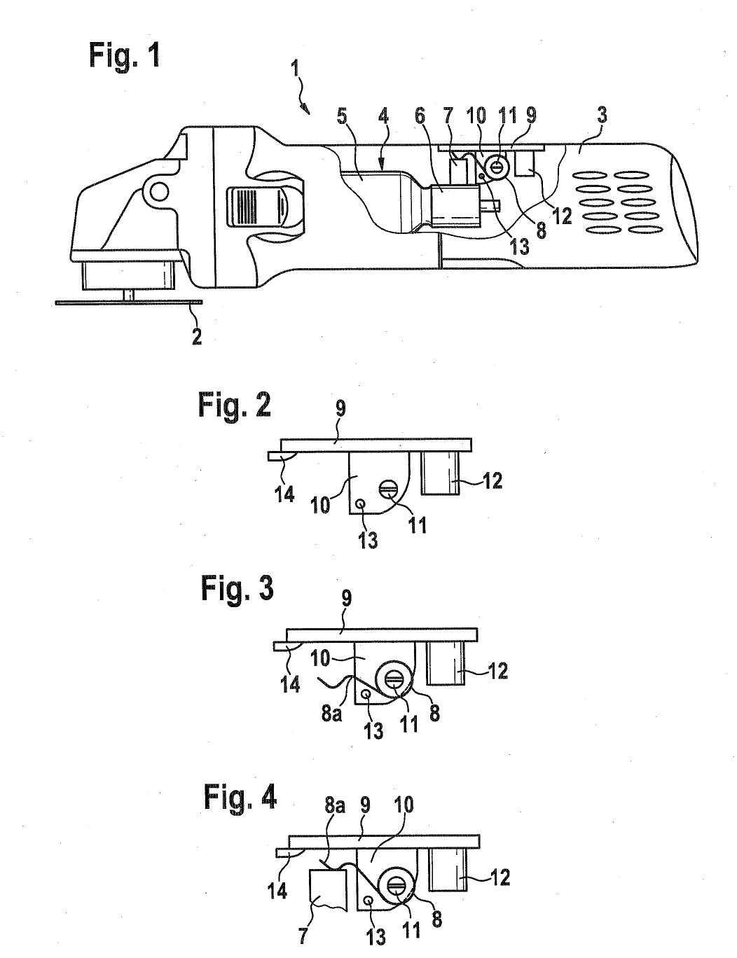

The hand-held power tool depicted in FIG. 1 is an angle grinder 1 whose schematically depicted tool 2 is driven via a transmission, not shown, by the armature 5 of an electric motor 4, which is embodied in the form of a universal motor. The armature 5 is connected to a commutator 6 against which a brush 7, which is secured so that it is affixed to the housing but can suitably move in the axial direction, rests in sliding fashion in order to transmit current to the winding of the armature 5. The brush 7 is acted on by the force of a spiral spring 8 in the direction toward the commutator 6 in order to assure a sufficient contact between the brush and commutator during ongoing operation. The spiral spring 8 is secured to a cover 9 that is detachably accommodated in the housing 3 of the angle grinder 1. This cover 9, on its underside oriented toward the housing interior, has a support plate 10 on which a retaining journal 11 is provided, which functions as the support for the spiral spring 8 in that the spiral spring 8 is slid onto the retaining journal 11 so that the rotation axis of the spiral spring coincides with the axis of the retaining journal. The cover 9 is to be fastened to the housing 3 of the power tool by means of a boss 12 that is provided to accommodate a screw. The support plate 10 is also provided with a stop 13 embodied in the form of a screw, which has the function of limiting the return movement of the spiral spring 8.

As is clear from FIG. 2, a protruding guide lug 14 is formed onto an end surface of the cover 9 and in the installed position of the cover, engages in an associated recess in the housing of the hand-held power tool. FIG. 2 also shows that the support plate 10 extends approximately perpendicular to the plane of the cover 9. The cover 9 is suitably embodied in the form of an injection molded plastic part and the guide lug 14, support plate 10, and boss 12 for accommodating a screw are embodied as integral to the cover. The retaining journal 11 and the stop 13 embodied in the form of a screw or the like can be embodied as separate components, are composed for example of metal, and are attached to the support plate 10, for example inserted into recesses in the support plate.

In FIG. 3, the spiral spring 8 has been slid onto the retaining journal 11. A freely extending leg 8a of the spiral spring 8 rests against the stop 13 that obstructs the further opening movement of the leg 8a. The stop 13 prevents the spiral spring from unwinding due to the action of its inherent stress.

In FIG. 4, the freely extending end of the leg 8a of the spiral spring 8 acts on the carbon brush 7 and presses it against the commutator 6 (FIG. 1) so that as the armature 4 rotates, a continuous contact between brush and commutator is assured for the transmission of current. When the cover 9 is inserted, the free end of the leg 8a rests against the top of the brush 7; in this position, the leg 8a is lifted up from the stop 13 so that the force of the spiral spring is not absorbed by the stop 13 but is instead transmitted entirely to the brush 7. At the same time, this has the advantage that when the fastening of the cover 9 to the housing is released, i.e. usually when the screw guided through the boss is unscrewed, the reaction force of the spiral spring 8 lifts the cover 9 up out of the recess in the housing, allowing it be easily grasped.

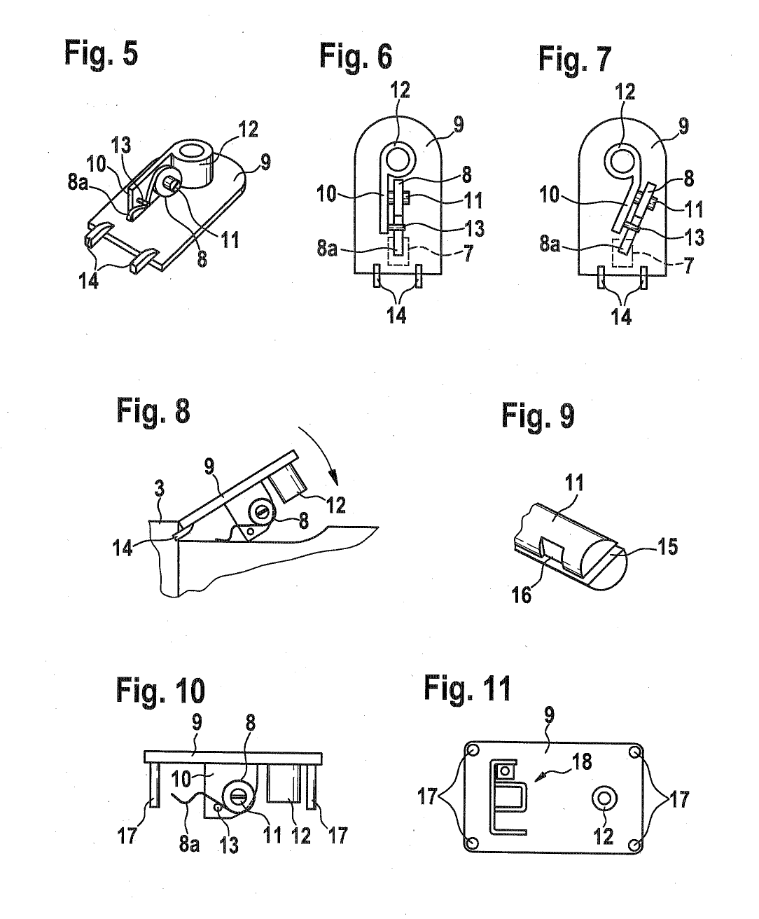

FIGS. 5 and 6 show two different perspectives of a cover 9. It is clear from FIG. 5 that the support plate 10 extends perpendicular to the plane of the cover 9. In addition, the support plate 10 is connected to the boss 12; the support plate 10 adjoins the boss 12 tangentially, which lends it additional stability. The support plate 10 extends in the longitudinal direction of the approximately rectangularly embodied cover 9.

FIG. 7 shows an embodiment variant in which the support plate 10 is oriented obliquely or at an angle in relation to the longitudinal direction of the cover 9 and encloses an angle of approximately 30° in relation to the longitudinal axis of the cover 9. The angular orientation results in the fact that the spiral spring 8 also extends at the same angle to the longitudinal axis.

In FIG. 8, the cover 9 is shown in a pivoted-open position. The guide lugs 14 that are situated on one end surface of the cover 9, engage in associated recesses in the housing 3 of the power tool, forming a hinge with a hinge axis around which the cover 9 can be pivoted open and closed.

FIG. 9 is an enlarged detail view of the retaining journal 11, which is provided to accommodate the spiral spring 8. An axially extending central slot 15 is provided in the end surface of the retaining journal 11 in order to accommodate one end of the spiral spring so that this end of the spiral spring is connected to the retaining journal 11 for co-rotation with it. A notch 16 is provided in the circumference surface of the retaining journal 11, spaced apart from the free end of the journal, and functions as an axial securing element for the spiral spring.

In the exemplary embodiment shown in FIGS. 10 and 11, guide pins 17 are provided, which are integral to the cover 9, extend perpendicular to the plane of the cover, and are situated at each corner of the cover. In the installed position, these guide pins 17 protrude into associated recesses in the housing and in this way, secure the cover in place. In addition, the screw in the boss 12 achieves a final attachment to the housing.

According to FIG. 11, a brush holder 18 for securing and accommodating the brush is provided on the underside of the cover. The brush holder 18 is embodied as a separate component that is fastened to the underside of the cover 9. The fastening is advantageously carried out in such a way that the brush is able to move inside the brush holder 18 at least a small distance in the operative direction of the spring element and can thus be pressed against the commutator by the spring element.

The spring must be able to travel a certain distance since this describes the service life/effective lifetime of the carbon brush. For example in small angle grinders, the carbon brush as a rule experiences from 5 to 7 mm of wear so that the spring should be able to exert a force on the brush over these 5 to 7 mm. In larger devices, the travel is correspondingly greater.

1-11. (canceled)

12. An electrically drivable hand-held power tool, comprising:
an electric drive motor that is accommodated in a housing of the hand-held power tool and is embodied in the form of a commutator motor equipped with a brush for transmitting current to a commutator;
a detachable cover provided in the housing which cover supports a spring element, which in an installed position, the spring element acts on the brush with a spring force in the direction toward the commutator.

13. The hand-held power tool as recited in claim 12, wherein the cover is provided with a support plate that functions as the support of the spring element.

14. The hand-held power tool as recited in claim 13, wherein the support plate extends perpendicular to the plane of the cover.

15. The hand-held power tool as recited in claim 13, wherein the support plate is provided with a retaining journal for accommodating the spring element.

16. The hand-held power tool as recited in claim 14, wherein the support plate is provided with a retaining journal for accommodating the spring element.

17. The hand-held power tool as recited in claim 13, wherein a stop for limiting the opening movement of the spring element is situated on the support plate.

18. The hand-held power tool as recited in claim 14, wherein a stop for limiting the opening movement of the spring element is situated on the support plate.

19. The hand-held power tool as recited in claim 15, wherein a stop for limiting the opening movement of the spring element is situated on the support plate.

20. The hand-held power tool as recited in claim 16, wherein a stop for limiting the opening movement of the spring element is situated on the support plate.

21. The hand-held power tool as recited in claim 13, wherein a boss for accommodating a screw is situated on the cover.

22. The hand-held power tool as recited in claim 14, wherein a boss for accommodating a screw is situated on the cover.

23. The hand-held power tool as recited in claim 15, wherein a boss for accommodating a screw is situated on the cover.

24. The hand-held power tool as recited in claim 17, wherein a boss for accommodating a screw is situated on the cover.

25. The hand-held power tool as recited in claim 21, wherein the support plate is connected to the boss.

26. The hand-held power tool as recited in claim 24, wherein the support plate is connected to the boss.

27. The hand-held power tool as recited in claim 21, wherein that cover, the support plate, and the boss are embodied as a one-piece injection molded part.

28. The hand-held power tool as recited in claim 26, wherein that cover, the support plate, and the boss are embodied as a one-piece injection molded part.

29. The hand-held power tool as recited in claim 12, wherein the spring element is embodied in the form of a spiral spring.

30. The hand-held power tool as recited in claim 12, wherein a brush holder for holding the brush is situated on the cover.

31. The hand-held power tool as recited in claim 12, wherein protruding guide lugs are formed onto the cover and in an installed position, protrude into associated recesses in the housing.
